(19) United States
(12) Patent Application Publication
(10) Pub. No.: US 2025/0053417 A1
(43) Pub. Date: Feb. 13, 2025

(54) DETERMINING INTRODUCTION POINT OF APPLICATION REGRESSIONS THROUGH SCREENSHOT ANALYSIS

(71) Applicant: Lenovo (Singapore) Pte. Ltd., Singapore (SG)

(72) Inventors: Timothy Robbins, Avon, IN (US); Matthew Fardig, Boonville, IN (US); Joshua Smith, Milton, FL (US)

(21) Appl. No.: 18/447,850

(22) Filed: Aug. 10, 2023

(51) Int. Cl. G06F 8/71; G06F 11/36; G06V 30/41

(52) U.S. Cl. CPC G06F 8/71; G06F 11/3684; G06V 30/41

(57) ABSTRACT

A system for software testing includes a storage device to store screenshots of a user application captured during execution of the user application. The system includes a computer vision device coupled to the storage device. The computer vision device can receive a description of an assertion to be detected within the screenshots. The computer vision device can scan the screenshots to detect presence of the assertion and provide an output indicating presence of the assertion. The screenshot can be stored in a way to associate the screenshot with a software build version or date to indicate a point at which the assertion was introduced into relevant software source code.

### TECHNICAL FIELD

Embodiments described herein generally relate to application regression detection, and in an embodiment, but not by way of limitation, analysis of screenshots to detect regressions.

### BACKGROUND

Software regression testing refers to software testing done to uncover regression bugs (i.e., errors) in successive versions of software. Regression bugs occur when software functionality that worked as desired in previous versions of a software product stop working in the intended way. Automated testing can be configured to perform regression testing, but some errors or bugs may still be released to users. When users discover or report these defects, it can be difficult to determine when the bugs were introduced into software because the automated regression tests did not detect when the regression was introduced before release. It can also be difficult to reproduce the defects in the software development and testing environment, further complicating the efforts of software developers to fix defects.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a high-level diagram of a system for detecting the introduction point of regressions according to some embodiments.

FIG. 2 is an example user display for illustrating an example execution of methods according to some embodiments.

FIG. 3 is a flowchart of a method for detecting the introduction point of regressions according to some embodiments.

FIG. 4 is a block diagram of a computer architecture upon which one or more of the embodiments disclosed herein can execute.

### DETAILED DESCRIPTION

A software regression is a type of software bug in which a feature that previously worked before stops working. This type of software bug may occur when changes are applied to the software source code. For example, software developers may introduce bugs when implementing new features or patches, or when fixing other bugs. Regression testing may be run after every software change to help ensure that the change introduces no software regressions or other unintended changes. Regression testing can be automated to implement after every software build or change to software, periodically (e.g., nightly or weekly) or according to developer needs or requests. Then, when a bug is discovered, it may be relatively easy or straightforward to pinpoint when the bug was introduced by pinpointing which iteration of automated regression testing discovered the bug.

However, some software regressions can still be inadvertently released to users. Because such bugs were not discovered during regression testing, it can be difficult to pinpoint when that bug occurred or was introduced into source code. Previous versions of the software can be loaded and tested to determine this introduction point, but such set up can be time consuming. Furthermore, it may be difficult to reproduce bugs because the exact user environment can be difficult to reproduce. For example, network load, time of day variation, unknown/unauthorized user devices, or other issues may have led to the occurrence of the bug/regression. Even when these variables and conditions are known, they can be difficult to reproduce in the software lab.

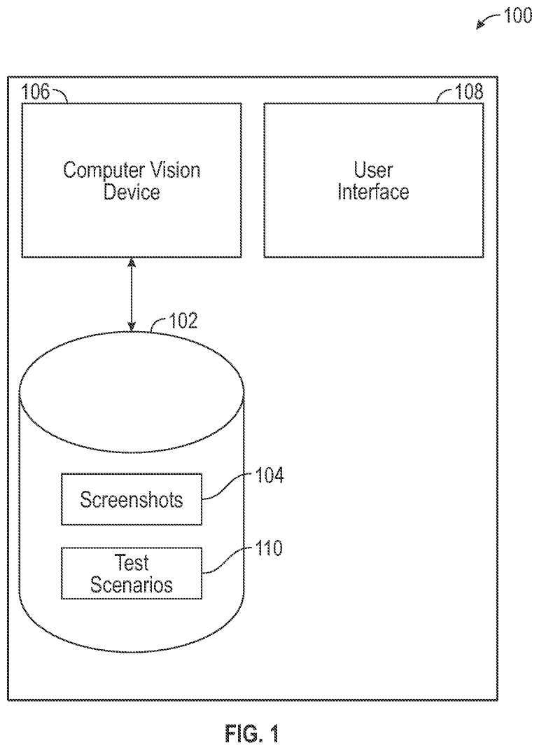

Systems and methods according to embodiments of the present disclosure address these and other concerns by analyzing images (e.g., “screenshots”) captured and saved during automated regression testing. Once presence of the regression is detected in the analyzed screenshots, the system can determine the date or software version of the application where the regression was introduced based on the date, software build version, or other information of the corresponding screenshot where the detection was made. FIG. 1 is a high-level diagram of a system 100 for detecting the introduction point of regressions according to some embodiments.

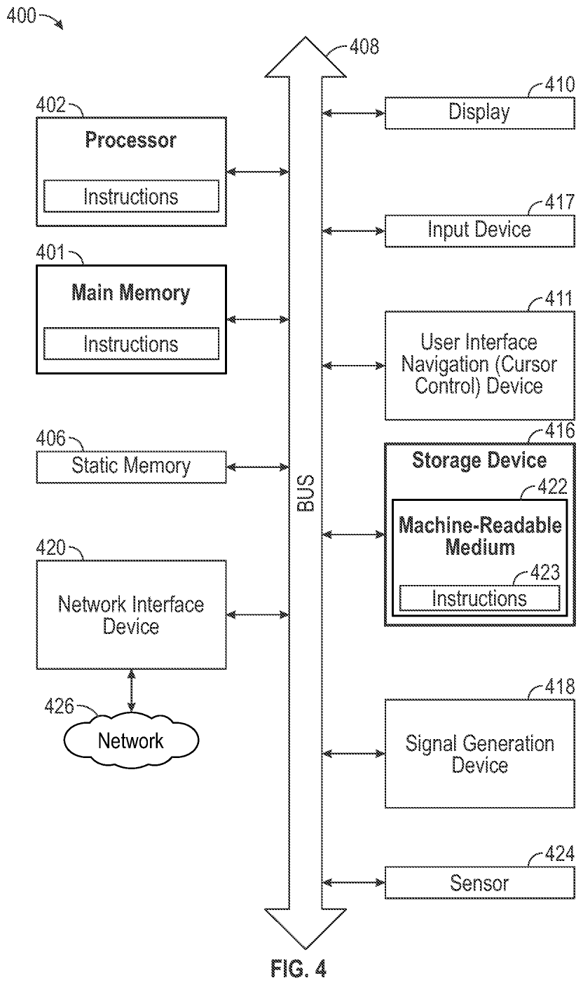

Referring to FIG. 1, the system 100 can be understood as including a computing device and can include other components not shown in FIG. 1 and described in more detail with reference to FIG. 4. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

The system 100 can include a storage device 102 configured to store a plurality of images (e.g., screenshots 104). The screenshots 104 can represent images captured during the recording of visible items displayed on a visual output device. In other examples, the images can be captured without a visual output device. For example, the automated tests can execute in the cloud (e.g., for example in a “headless” testing format) where there is no visible browser, user output, etc. with screenshots 104 nevertheless being captured. The visible items can correspond to or pertain to a user application and the screenshots can be captured during execution of the user application. The screenshots 104 may have been captured in previous automated or manual regression testing. For example, the software application/s under test will have previously executed several times (periodically or on demand according to software developer request/team lead request) and user interface screenshots 104 will have been captured at each point (using automated regression testing software or tools) and stored in the storage device 102.

When an application regression is discovered by a user or customer (e.g., not by the software testers or developers), the user can specify the conditions under which the regression occurred (if known) or the state that the application was in when the regression occurred. The user may specify (when known) the steps taken by the user that led up to the occurrence of the regression. For example, the user may state that 20 people logged onto the application right before the aggression occurred, or that the regression occurred at 8 AM every day. This information can be used by the application developer/tester in narrowing down the possible cause or in creating a reproducible environment for reproducing the regression. The application developer/tester can also use these conditions or other analysis to narrow down the scope of screenshots to be analyzed by the computer vision device 106.

In example embodiments, the application developer/tester can use the user interface 108 to set parameters and conditions for the computer vision device 106. For example, the software developer can specify a condition to be tested (e.g., a “regression assertion”) using computer vison-based natural language. If the condition evaluates to “true” this can indicate that the computer vision device 106 has detected presence of the condition within that screenshot. Responsive to detecting presence of the condition in a screenshot, the computer vision device 106 determines that the regression was present in the software version or build that generated that screenshot. Similarly, if presence of the condition is not detected in a screenshot, the computer vision device 106 determines that the regression was not present in the software version or build that generated that screenshot. The user interface 108 can display an indication of presence of the assertion, an indication of a software build number, or any other data regarding the assertion, screenshot, software, etc. that may be provided by the computer vision device 106 or retrieved from the storage device 102. The user interface 108 can also provide other inputs to the computer vision device 106 including conditional statements limiting the scan to a date range, a software build number range, a user application state, etc.

The computer vision device 106 can proceed backward in time in analysis of screenshots 104 until detection of the regression condition. Alternatively, scanning algorithms can be implemented to determine which screenshots 104 to analyze. For example, bisection algorithms can be used to narrow down the number of screenshots examined or to determine which screenshots to examine. As an illustrative example, if a software build dated four months ago did not include the regression, but a software build dated two months ago did include the regression, the system 100 can be programmed to instruct the computer vision device 106 to retrieve and examine a screenshot 104 from a software build dated halfway (e.g., a bisection date) between four months ago and two months ago (e.g., about three months ago in this example). If the next-examined screenshot (e.g., a screenshot from three months ago) does not include the tested-for regression, then the computer vison device 106 can determine that the regression was introduced between three and two months ago. Similar bisection can be performed again to narrow down the exact date of introduction between three and two months ago. Bisection can occur iteratively until two sequential screenshots are found: the earlier of the screenshots not including the regression and the later of the screenshots including the regression. The software build or version number pertaining to the later of the screenshots can therefore be determined to have introduced the regression of interest.

The computer vision device 106 can examine and identify components of screenshots 104 on pixel-by-pixel basis to identify different components, colors, etc. within a screenshot. Before or during identification, the computer vision device 106 can perform display operations such as reducing noise, changing device settings, contrast settings, applying noise filters, etc., or these operations can be performed by related display circuitry shown in FIG. 4.

A developer or quality assurance personnel can develop and update test scenarios 110 to create a test scenario library. Each scenario 110 can include instructions that simulate user interactions with the user application. For example, a test scenario 110 could include instructions that generate a mouse over, a hover, text input, a selection of a component, and other interactions. Each scenario 110 can include instructions for loading or executing the test through a plurality of different virtual machines or on different networks under different loads. Upon generating a test user interface, a screenshot can be generated by the test platform and stored in storage device 102.

Test scenarios 110 can be updated, enhanced or added based on machine learning algorithms as regressions are reported by users or in additional automated regression testing. The test scenarios 110 can be included in subsequent automated or manual regression testing either on system 100 or on a dedicated test platform or system (not shown in FIG. 1). Over time, the testing data can be used to determine which software modules are most likely to cause problems. This information can be used as feedback to select more vigorous testing for those software modules that more frequently cause visual regressions. The machine learning algorithms can also predict conditions under which subsequent user application errors will occur.

The storage device 102 can store the screenshots 104, test scenarios 110, etc. in a relational database. The relational database can associate the screenshots 104 with software version information of the respective user application. The computer vision device 106 can determine which software build/version was associated with an assertion based on indexing information, keys, etc. associated with the screenshot in which the assertion was detected.

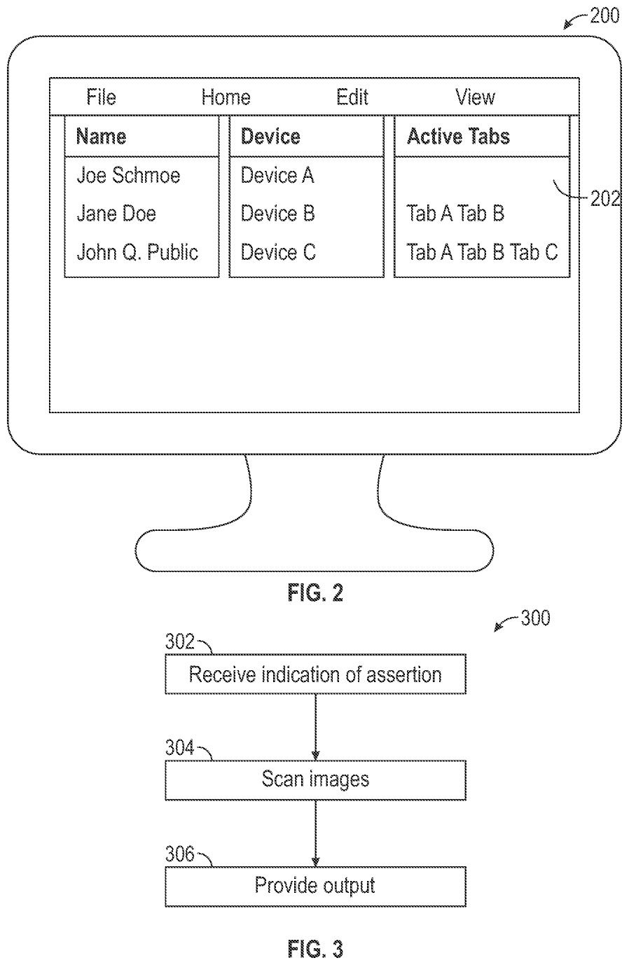

FIG. 2 is an example user display 200 for illustrating an example execution of methods according to some embodiments. As seen in FIG. 2, a user application may include the illustrated page listing students in a virtual classroom. Each row can pertain to one student and include information including name, device name/type, and a list of their active browser tabs. Assume by way of an example that a user or QA personnel notices the following assertion: for one type of virtual classroom, students with one type of device do not have any listings under the Active tabs column as shown at reference number 202.

The software development team may next wish to determine when the error was introduced. This knowledge can be of use in fixing the error and in determining the scope of the error, in triage to determine the priority of the bug fix, etc. Assuming that the automated regression testing did not discover the assertion, the software development team nevertheless has access to screenshots (e.g., screenshots 104 (FIG. 1)) from regression testing dating back to the first version or build of the relevant software.

The user interface 108 can be used to provide different parameters and conditions to the computer vision device 106. For example, an application state can be provided, which can include natural-language parameters listing the name of the page to be examined, date ranges, classroom types, device types, etc. A regression assertion can be provided. For example, a regression assertion of “any text” can be provided to specify that any text be present in the column under “Active tabs” as shown in FIG. 2 for any device of type Device A.

Next, a scan can be started and available screenshots can be retrieved and scanned in reverse chronological order or according to bisection algorithms described earlier herein or other algorithms. Any screenshot that does not meet specified conditions may not be scanned (e.g., any screenshot that does not have the specified page name may not be scanned). After matches are found, the computer vision device 106 can analyze each matching screenshot by checking if the “Active tabs” column has some text in it for the Device A rows. Screenshots taken near the day regression was noticed may include the regression (e.g., “any text” evaluates to FALSE). At some point previous to this, however, the computer vision device 106 may locate a screenshot where there is text in that column (e.g., the regression assertion “any text” evaluates to TRUE). Therefore, the computer vision device 106 can determine the software build or version at which the regression was introduced, because the regression would have been introduced at the build where the regression assertion evaluation changed from TRUE to FALSE.

FIG. 3 is a flowchart of a method 300 for detecting the introduction point of regressions according to some embodiments. The method can be performed by the computer vision device 106 or any component of FIG. 1 or FIG. 4. Method 300 can begin with operation 302 by the computer vision device 106 receiving an indication of an assertion to be detected within a plurality of screenshots of a user application captured during execution of the user application. The assertion can be defined using computer vision device 106 natural-language based definitions.

The screenshots may have been generated by previously-executed automated tests of the user application. The screenshots can be accessed from a relational database. The relational database may associate the plurality of screenshots with software version information of the respective user application.

Method 300 can continue with operation 304 with the computer vision device 106 scanning the plurality of screenshots to detect a presence of the assertion. As described above, this can be based on evaluating the regression assertion provided by the user interface 108. At operation 306, the computer vision device 106 can provide output indicating presence of the assertion. Other information can be provided in the output, including an indication of the first software version at which the regression was present (e.g., an indication of where the assertion was inadvertently inserted into the source code or caused the regression in the source code).

FIG. 4 is a block diagram illustrating a computing and communications platform 400 in the example form of a general-purpose machine on which some or all the operations of FIGS. 1-3 may be carried out according to various embodiments. In certain embodiments, programming of the computing platform 400 according to one or more particular algorithms produces a special-purpose machine upon execution of that programming. In a networked deployment, the computing platform 400 may operate in the capacity of either a server or a client machine in server-client network environments, or it may act as a peer machine in peer-to-peer (or distributed) network environments.

Example computing platform 400 includes at least one processor 402 (e.g., a central processing unit (CPU), a graphics processing unit (GPU) or both, processor cores, compute nodes, etc.), a main memory 401 and a static memory 406, which communicate with each other via a link 408 (e.g., bus). The computing platform 400 may further include a video display unit 410, input devices 417 (e.g., a keyboard, camera, microphone), and a user interface (UI) navigation device 411 (e.g., mouse, touchscreen). The computing platform 400 may additionally include a storage device 416 (e.g., a drive unit), a signal generation device 418 (e.g., a speaker), a sensor 424, and a network interface device 420 coupled to a network 426.

The storage device 416 includes a non-transitory machine-readable medium 422 on which is stored one or more sets of data structures and instructions 423 (e.g., software) embodying or utilized by any one or more of the methodologies or functions described herein. The instructions 423 may also reside, completely or at least partially, within the main memory 401, static memory 406, and/or within the processor 402 during execution thereof by the computing platform 400, with the main memory 401, static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed database, and/or associated caches and servers) that store the one or more instructions 423. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first.” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

### EXAMPLES

Example 1 is a system for software testing, the system comprising: a storage device configured to store a plurality of screenshots of a user application captured during execution of the user application; and a computer vision device coupled to the storage device, the computer vision device configured to: receive a description of an assertion to be detected within the plurality of screenshots; scan the plurality of screenshots to detect presence of the assertion; and provide output indicating presence of the assertion.

In Example 2, the subject matter of Example 1 can optionally include wherein the plurality of screenshots are stored in a relational database, the relational database associating the plurality of screenshots with software version information of the respective user application, and wherein the output indicates a first software version at which the assertion was present.

In Example 3, the subject matter of Example 2 can optionally include a user interface component coupled to the computer vision device, wherein the user interface component is configured to display an indication of presence of the assertion and an indication of a software build number.

In Example 4, the subject matter of Example 3 can optionally include wherein the computer vision device is configured to receive one or more conditional statements from the user interface component, the one or more conditional statements limiting the scan to at least one of a date range, a software build number range, and an user application state.

In Example 5, the subject matter of Example 4 can optionally include wherein the computer vision device includes machine learning circuitry to predict conditions under which subsequent user application errors will occur.

In Example 6, the subject matter of Example 5 can optionally include wherein the system is configured to generate additional automated tests based on the predicted conditions.

In Example 7, the subject matter of any of Examples 1-6 can optionally include wherein the assertion is defined using computer vision device natural-language based definitions.

In Example 8, the subject matter of any of Examples 1-7 can optionally include wherein the plurality of screenshots are generated by automated tests of the user application.

Example 9 is a method comprising: receiving an indication of an assertion to be detected within a plurality of screenshots of a user application during execution of the user application, the assertion being defined using computer vision device natural-language based definitions and the plurality of screenshots being generated by previously-executed automated tests of the user application; scanning the plurality of screenshots to detect a presence of the assertion; and providing output indicating presence of the assertion.

In Example 10 the subject matter of Example 9 can optionally include accessing plurality of screenshots from a relational database, the relational database associating the plurality of screenshots with software version information of the respective user application, and wherein the output indicates a first software version at which the regression was present.

In Example 11, the subject matter of Example 10 can optionally include displaying an indication of presence of the assertion and an indication of a software build number at which a corresponding error or software bug was introduced into the associated user application.

In Example 12, the subject matter of Example 10 can optionally include receiving one or more conditional statements limiting the scan to at least one of a date range, a software build number range, and a user application state.

In Example 13, the subject matter of Example 12 can optionally include predicting conditions, based on a machine learning model, under which subsequent user application errors will occur.

In Example 14, the subject matter of Example 13 can optionally include generating additional automated tests based on the predicted conditions.

Example 15 is a machine-readable medium including instructions that, when executed on a processor, cause the processor to perform operations including any of the operations described in Examples 1-14.

1. A system for software testing, the system comprising:
a storage device configured to store a plurality of screenshots of a user application captured during execution of the user application; and
a computer vision device coupled to the storage device, the computer vision device configured to:
receive a description of an assertion to be detected within the plurality of screenshots;
scan the plurality of screenshots to detect presence of the assertion; and
provide output indicating presence of the assertion.

2. The system of claim 1, wherein the plurality of screenshots are stored in a relational database, the relational database associating the plurality of screenshots with software version information of the respective user application, and wherein the output indicates a first software version at which the assertion was present.

3. The system of claim 2, further comprising a user interface component coupled to the computer vision device, wherein the user interface component is configured to display an indication of presence of the assertion and an indication of a software build number.

4. The system of claim 3, wherein the computer vision device is configured to receive one or more conditional statements from the user interface component, the one or more conditional statements limiting the scan to at least one of a date range, a software build number range, and an user application state.

5. The system of claim 4, wherein the computer vision device includes machine learning circuitry to predict conditions under which subsequent user application errors will occur.

6. The system of claim 5, wherein the system is configured to generate additional automated tests based on the predicted conditions.

7. The system of claim 1, wherein the assertion is defined using computer vision device natural-language based definitions.

8. The system of claim 1, wherein the plurality of screenshots are generated by automated tests of the user application.

9. A method comprising:
receiving an indication of an assertion to be detected within a plurality of screenshots of a user application during execution of the user application, the assertion being defined using computer vision device natural-language based definitions and the plurality of screenshots being generated by previously-executed automated tests of the user application;
scanning the plurality of screenshots to detect a presence of the assertion; and
providing output indicating presence of the assertion.

10. The method of claim 9, further comprising:
accessing plurality of screenshots from a relational database, the relational database associating the plurality of screenshots with software version information of the respective user application, and wherein the output indicates a first software version at which the regression was present.

11. The method of claim 10, further comprising displaying an indication of presence of the assertion and an indication of a software build number at which a corresponding error or software bug was introduced into the associated user application.

12. The method of claim 10, further comprising receiving one or more conditional statements limiting the scan to at least one of a date range, a software build number range, and a user application state.

13. The method of claim 12, further comprising predicting conditions, based on a machine learning model, under which subsequent user application errors will occur.

14. The method of claim 13, further comprising generating additional automated tests based on the predicted conditions.

15. A machine-readable medium including instructions that, when executed on a processor, cause the processor to perform operations including:
receiving an indication of an assertion to be detected within a plurality of screenshots of a user application during execution of the user application, the assertion being defined using computer vision device natural-language based definitions and the plurality of screenshots being generated by previously-executed automated tests of the user application;
scanning the plurality of screenshots to detect a presence of the assertion; and
providing output indicating presence of the assertion.

16. The machine-readable medium of claim 15, wherein the operations further comprise:
accessing the plurality of screenshots form a relational database, the relational database associating the plurality of screenshots with software version information of the respective user application, and wherein the output indicates a first software version at which the assertion was present.

17. The machine-readable medium of claim 16, wherein the operations further comprise displaying an indication of presence of the assertion and an indication of a software build number at which a corresponding error or software bug was introduced into the associated user application.

18. The machine-readable medium of claim 16, wherein the operations further comprise receiving one or more conditional statements limiting the scan to at least one of a date range, a software build number range, and a user application state.

19. The machine-readable medium of claim 18, wherein the operations further comprise predicting conditions, based on a machine learning model, under which subsequent user application errors will occur.

20. The machine-readable medium of claim 19 wherein the operations further comprise generating additional automated tests based on the predicted conditions.
